(19) United States
(12) Patent Application Publication
(10) Pub. No.: US 2017/0066984 A1
(43) Pub. Date: Mar. 9, 2017

(54) LOW SULFUR BIODIESEL COMPOSITION AND METHOD OF MAKING

(71) Applicant: AGRON BIOENERGY, LLC, WATSONVILLE, CA (US)

(72) Inventors: Michael Phillip Doyle, Carmel, CA (US); Roxby Hartley, Carmel, CA (US); Leland Doyle, Seaside, CA (US); William L. Selden, JR., Aptos, CA (US); Andrew Meissner, Monterey, CA (US)

(21) Appl. No.: 15/257,602

(22) Filed: Sep. 6, 2016

Related U.S. Application Data
(60) Provisional application No. 62/213,887, filed on Sep. 3, 2015.

(51) Int. Cl. C10L 1/02; C11C 1/10; B01J 19/24; C11C 3/00

(52) U.S. Cl. CPC C10L 1/026; C11C 3/00; C11C 1/10; B01J 19/245; C10L 2200/0263; C10L 2200/04; C10L 2230/14; C10L 2230/22; C10L 2200/0259; C10L 2230/088; C10L 2270/026; C10L 2200/0476; C10L 2290/543; C10L 2290/06; B01J 2219/24

(57) ABSTRACT

The invention provides fatty acid methyl ester fuel compositions and methods of making same.

### CROSS-REFERENCES TO RELATED APPLICATIONS

This application claims the benefit of U.S. Provisional Application No. 62/213,887, filed Sep. 3, 2015, which is incorporated in its entirety herein for all purposes.

### STATEMENT AS TO RIGHTS TO INVENTIONS MADE UNDER FEDERALLY SPONSORED RESEARCH AND DEVELOPMENT

NOT APPLICABLE

### BACKGROUND OF THE INVENTION

Vehicles and stationery equipment with Tier 0 through Tier 3 compression ignition engines can exhibit high emissions and be subject to regulations. Maintaining compliance with these regulations can require the installation of expensive and high-maintenance particulate filters, and/or the replacement of engines with lower emission models. The harmful effects of emissions on environmental quality and health can be mitigated in part through the use of fuels such as those derived from fatty acid methyl esters (FAME). Emissions characteristics such as Particulate Matter (PM), Total Hydrocarbons (THC) and carbon monoxide (CO) are typically lower in engines fueled with traditional FAME than in those fueled with petroleum diesel.

Engine emissions from the use of FAME made from traditional methods also can have increased nitrogen oxide (NOx) as compared to emissions from the use of petroleum diesel. NOx is a contributor to the formation of smog in California and other regions, where laws prohibit increased emissions of NOx. As a result, some regulatory agencies such as the California Air Resources Board (CARB) have considered or decided to limit the amount of traditional FAME that can be added to petroleum diesel.

Also, un-combusted and combusted FAME of seed oil (rapeseed, soy, camellia and the like) and animal tallows (beef, poultry and the like) typically has an odor indicative of the oil the methyl ester is created from. In some cases the exhaust odor of a combustion engine fueled with FAME is so strong as to be offensive to pedestrians and motorists following the vehicle. In other cases, the use of FAME in a stationary engine can produce an odor too offensive to allow the engine to operate with that fuel type. Furthermore, typical FAME when spilled, especially on one's hands or clothing, may cause a prolonged bad odor. FAME fuels stored in equipment contained in garages, basements, sheds, or even houses can also emit an odor that may make it undesirable to store engine equipment or fuel indoors.

Several factors lead to FAME odor. Eliminating only some of the factors can result in an otherwise advanced FAME that still has an unacceptable odor. Understanding and controlling most or all the factors is necessary to achieve a fuel that has a truly low odor level, no odor, or even a pleasant odor. On the other hand, if one eliminates the odor and NOx contributing components from the FAME, the FAME may no longer meet American Society of the International Association for Testing and Materials (ASTM) D6751, the specification for biodiesel.

Others have described methods for the advanced refining of raw reacted fatty acid based fuel to alter its properties. Fleckenstein et al. (U.S. Pat. No. 5,043,485) teach a process for the hydrogenation of FAME mixtures. This process employs elevated temperature, pressure, mixtures of metal catalysts and added hydrogen to produce fatty alcohols. Doyle et al. (U.S. Pat. No. 8,901,330) teach a process for making FAME without water by employing a centrifuge. Furthermore, this FAME is produced in a continuous manner at elevated temperature and pressure with reduced catalysts amounts. The process is then followed by a distilling process to produce essentially pure fatty acid methyl esters. Jackam et al. (U.S. Pat. No. 8,728,177) teach methods to reduce free fatty acid (FFA) in a FAME feedstock through glycerolysis, a method of reacting a glycerol ester with and without a catalyst during reactive distillation. The methods further discuss the removal of impurities via settling and distillation.

Each of the above methods provides a different approach to the production of biodiesel, but none is capable of generating a fuel combining a low odor with reduced nitrogen and other desired fuel properties. Only by careful balancing of FAME production plant operating conditions can a compliant biofuel be produced that has both low odor and low or neutral NOx. In addressing this balance, the present invention surprisingly meets the need for a biodiesel fuel having reduced odor and NOx emissions as well as other needs.

### BRIEF SUMMARY OF THE INVENTION

In one embodiment, the present invention provides a fatty acid ester fuel composition comprising at least one fatty acid ester. The composition has at least five of the following:
a. a sulfur content of less than about 10 ppm,
b. a nitrogen content of less than about 10 ppm,
c. a flash point of greater than about 93° C.,
d. a 5% distillation temperature of at least about 220° C.,
e. a 95% distillation temperature of less than about 355° C.,
f. a cetane number of greater than about 60,
g. a free glycerin content of less than about 0.009% (w/w),
h. a total glycerin content of less than about 0.045% (w/w),
i. a cloud point of less than about 10° C.,
j. a UV absorbance, Aₜₒₜₐₗ, of less than about 1.5, and
k. a clarity value of about 1 as measured by ASTM D4174.

In a second embodiment, the present invention provides a method of preparing the fatty acid ester fuel composition of the present invention. The method comprises heating a fatty acid methyl ester feedstock in a first vacuum tower at a temperature of at least about 500° F. and a pressure of less than about 760 Torr. The method further comprises separating a first fraction of glycerin thereby providing a first fraction of fatty acid methyl ester substantially free of an alcohol and having a total glycerin content of less than about 1% (w/w). The method further comprises heating the first fraction of fatty acid methyl ester in a second vacuum tower at a temperature of at least about 600° F. and a pressure of less than about 760 Torr. The method further comprises separating a second fraction of glycerin from the first fraction of fatty acid methyl ester to form a second fraction of fatty acid methyl ester having a free glycerin content of less than about 0.02% (w/w) and a total glycerin content of less than about 0.05% (w/w), thereby forming the fatty acid methyl ester fuel of the present invention.

In a third embodiment, the present invention provides a system for preparing the fatty acid ester fuel composition of the present invention. The system comprises a first vacuum tower having a bottom and a top. The system further comprises a second vacuum tower having a bottom and a top. The second vacuum tower is connected to the bottom of the first vacuum tower via a first pipe. The system further comprises a first overhead partial condenser connected to the top of the second vacuum tower. The system further comprises a first secondary condenser connected to the first partial condenser via a second pipe. The system further comprises a third vacuum tower having a bottom and a top. The third vacuum tower is connected to the bottom of the second vacuum tower via a third pipe. The third vacuum tower is also connected at the top to a second overhead partial condenser, a second secondary condenser, and a re-boiler.

### BRIEF DESCRIPTION OF THE DRAWINGS

FIG. 1 is a schematic illustration of a system for preparing fatty acid ester fuel compositions in accordance with an embodiment.

FIG. 2 is a table presenting characteristic data for a fatty acid ester fuel composition in accordance with an embodiment.

FIG. 3 is a table presenting characteristic data for a fatty acid ester fuel composition in accordance with an embodiment.

### DETAILED DESCRIPTION OF THE INVENTION

### I. General

The present invention provides fatty acid ester fuel compositions having reduced sulfur, nitrogen, and odor. The present invention also provides methods and systems for preparing the fatty acid ester fuel compositions of the present invention.

It has been discovered that reducing or eliminating the odor and reducing NOx from fatty acid methyl ester (FAME) fuels can be achieved by employing novel methods of advanced refining to reduce concentrations of several non-fuel components in the FAME fuel composition. These components can include glycerin; unreacted monoglycerides, diglycerides and triglycerides; amino acids; sterol glycosides, and other impurities. It has also been discovered that novel distilling techniques (combinations of temperature, pressure, flow rate and re-boiling) further alter the FAME structure. These alterations can result in changes to the flash point of a FAME fuel composition, boiling points during lab distillation, and other physical properties, while producing a less odorous, low-NOx FAME.

It has also been discovered that FAME made using the advanced refining techniques of this invention exhibit lower Particulate Matter (PM), Total Hydrocarbon (THC), and carbon monoxide (CO) emissions than petroleum diesel. FAME fuel compositions of the present invention are also NOx neutral to petroleum diesel in blends with petroleum diesel up to 20% FAME (B20). FAME made using the advanced refining techniques of this invention is compliant with the California Air Resource Board (CARB) Alternative Diesel Fuel Regulation effective Jan. 1, 2016.

### II. Definitions

The abbreviations used herein have their conventional meaning within the chemical and biological arts.

The term “fatty acid” is used herein to refer to a carboxylic acid having a long aliphatic chain. The aliphatic chain can be either saturated or unsaturated. The aliphatic chain can be either branched or unbranched. The aliphatic chain can have an even or odd number of carbon atoms. The fatty acid can have a chain of 4 carbon atoms, 6 carbon atoms, 8 carbon atoms, 10 carbon atoms, 12 carbon atoms, 14 carbon atoms, 16 carbon atoms, 18 carbon atoms, 20 carbon atoms, 22 carbon atoms, 24 carbon atoms, 26 carbon atoms, 28 carbon atoms, or more than 28 carbon atoms. The fatty acid can have a chain with 0 carbon double bonds, 1 carbon double bond, 2 carbon double bonds, 3 carbon double bonds, 4 carbon double bonds, 5 carbon double bonds, 6 carbon double bonds, or more than 6 carbon double bonds. The carbon atoms on either side of a double bond in the chain can occur in a cis or trans configuration. For example, fatty acid includes, but is not limited to, myristoleic acid, palmitoleic acid, sapienic acid, oleic acid, elaidic acid, vaccenic acid, linoleic acid, linolaidic acid, alpha-linolenic acid, arachidonic acid, eicosapentaenoic acid, erucic acic, docosahexaenoic acid, caprylic acid, capric acid, lauric acid, myristic acid, palmitic acid, stearic acid, arachidic acid, behenic acid, lignoceric acid, and cerotic acid. One of skill in the art will appreciate that other fatty acids are useful in the present invention.

The term “fatty acid ester” is used herein to refer to an ester resulting from a combination of a fatty acid with an alcohol. When the alcohol component is glycerol, the fatty acid ester can be a monoglyceride, a diglyceride, or a triglyceride. A fatty acid ester can be transesterified with methanol to produce a fatty acid methyl ester (FAME). A fatty acid ester can be transesterified with ethanol to produce a fatty acid ethyl ester (FAEE).

The term “alcohol” is used herein to refer to an alkyl group having a hydroxy group attached to a carbon of the chain. For example, alcohol includes, but is not limited to, methanol, ethanol, propanol, isopropanol, butanol, isobutanol, tert butanol, pentanol and hexanol, among others. One of skill in the art will appreciate that other alcohols are useful in the present invention

The term “alkyl” is used herein to refer to a straight or branched, saturated, aliphatic radical having the number of carbon atoms indicated. Alkyl can include any number of carbons, such as C₁₋₂, C₁₋₃, C₁₋₄, C₁₋₅, C₁₋₆, C₁₋₇, C₁₋₈, C₁₋₉, C₁₋₁₀, C₂₋₃, C₂₋₄, C₂₋₅, C₂₋₆, C₃₋₄, C₃₋₅, C₃₋₆, C₄₋₅, C₄₋₆ and C₅₋₆. For example, C₁₋₆ alkyl includes, but is not limited to, methyl, ethyl, propyl, isopropyl, butyl, isobutyl, sec-butyl, tert-butyl, pentyl, isopentyl, hexyl, etc. Alkyl can also refer to alkyl groups having up to 20 carbons atoms, such as, but not limited to heptyl, octyl, nonyl, decyl, etc. Alkyl groups can be substituted or unsubstituted

The term “fuel” is used herein to refer to a molecule or mixture of molecules that can be combusted to release energy. A fuel can be a liquid mixture of aliphatic hydrocarbons.

The term “flash point” is used herein to refer to the property of a material defining the lowest temperature at which vapors of the material will ignite. The flash point of a material can be measured according to standard test methods, such as those of the European Committee for Standardization (CEN)/International Organization for Standardization (ISO) Joint Working Group on Flash Point (JWG-FP), the American Society for Testing Materials (ASTM) D02.8B Flammability Section, and the Energy Institute's TMS SC-B-4 Flammability Panel.

The term “cold soak filtration time” is used herein to refer to the property of a liquid fuel defining the amount of time required to pass the liquid fuel through a filter after cooling to a target temperature. The cold soak filtration time can be measured according to standard test methods, such as those of ASTM D7501 or ASTM D3117. The cold soak filtration time can be measured, for example, by storing 300 mL of liquid fuel at 4.5° C. for 16 hours, warming the liquid fuel to 25° C., and vacuum filtering the liquid fuel through a 0.7-μm glass fiber filter at 70-85 kPa.

The term “distillation temperature” is used herein to refer to the property of a liquid fuel composition defining the boiling temperature at which a specified percentage of the liquid fuel composition is vaporized during distillation. A 5% distillation temperature is the boiling temperature at which 5% of distilled liquid can be recovered. A 95% distillation temperature is the boiling temperature at which 95% of distilled liquid can be recovered.

The term “cetane number” is used herein to refer to the property of a liquid fuel indicative of the time period between the start of an injection of the liquid fuel into a compression engine, and the first identifiable pressure increase upon combustion of the liquid fuel within the compression engine. The cetane number can be measured according to standard test methods, such as those of ASTM D613, ASTM D6890, and ASTM D7170.

The terms “free glycerin content” and “total glycerin content” are used herein to refer to the property of a liquid fuel defining the concentration of glycerin-containing compounds within the fuel composition. Glycerin molecules are quantified as free glycerin, while glycerin, together with unreacted triglycerides are quantified as total glycerin. The free and total glycerin contents can be measured according to standard test methods, such as those of ASTM D6584.

The term “cloud point” is used herein to refer to the property of a liquid fuel defining the temperature below which the liquid fuel begins to separate into two phases. The phase separation for a diesel fuel can involve the generation of solidified waxes that form a cloudy appearance within the fuel. The cloud point can be measured according to standard test methods, such as those of ASTM D2500, ASTM D5771, ASTM D5772, and ASTM D5773.

The term “nitrogen oxide emissions” is used herein to refer to emissions of mono-nitrogen oxides (NOx) nitric oxide and nitrogen dioxide released from the combustion of a liquid fuel. Emissions can be verified by, for example, using University of California Riverside College of Engineering Center for Environmental Research & Technology (CE-CERT) Federal Test Procedure (FTP) compliant fixed frame engine testing. These CARB protocols and procedures are set forth under Title 13, California Code of Regulations, §2281 and §2282

The terms “first”, “second”, and “third” when used herein with reference to vacuum towers, fractions, condensers, pipes, or other elements or properties are simply to more clearly distinguish the two or more elements or properties and are not intended to indicate order.

The terms “about” and “approximately equal” are used herein to modify a numerical value and indicate a defined range around that value. If “X” is the value, “about X” or “approximately equal to X” generally indicates a value from 0.90X to 1.10X. Any reference to “about X” indicates at least the values X, 0.90X, 0.91X, 0.92X, 0.93X, 0.94X, 0.95X, 0.96X, 0.97X, 0.98X, 0.99X, 1.01X, 1.02X, 1.03X, 1.04X, 1.05X, 1.06X, 1.07X, 1.08X, 1.09X, and 1.10X. Thus, “about X” is intended to disclose, e.g., “0.98X.” When “about” is applied to the beginning of a numerical range, it applies to both ends of the range. Thus, “from about 6 to 8.5” is equivalent to “from about 6 to about 8.5.” When “about” is applied to the first value of a set of values, it applies to all values in that set. Thus, “about 7, 9, or 11%” is equivalent to “about 7%, about 9%, or about 11%.”

### III. Compositions of Fatty Acid Ester Fuels

The present invention provides several compositions of fatty acid ester fuels. The composition include at least one fatty acid ester, and have at least five of the following:
a. a sulfur content of less than about 10 ppm,
b. a nitrogen content of less than about 10 ppm,
c. a flash point of greater than about 93° C.,
d. a 5% distillation temperature of at least about 220° C.,
e. a 95% distillation temperature of less than about 355° C.,
f. a cetane number of greater than about 60,
g. a free glycerin content of less than about 0.009% (w/w),
h. a total glycerin content of less than about 0.045% (w/w),
i. a cloud point of less than about 10° C.,
j. a UV absorbance, Aₜₒₜₐₗ, of less than about 1.5, and
k. a clarity value of about 1 as measured by ASTM D4174.

In some embodiments, the fatty acid ester fuel is a Compression Ignition Engine Blend Stock Composition (CIEBSC). Typical CIEBSC formulations comprise various components that can include sulfur compounds, nitrogen compounds, aromatic compounds, and volatile compounds sometimes referred to as light ends. Without being bound by any particular theory, it is believed that reduction of the concentrations of heteroatom-containing compounds and aromatic compounds within a CIEBSC can lead to a decrease in the odor associated with the composition. Aromatic compounds present in the compositions can include sterol glycosides. The presence of high molecular weight compounds such as monoglycerides, diglycerides, triglycerides, and sterol glycosides, can also cause uneven fuel burn rates and can further increase NOx emissions. In some embodiments, volatile light ends are substantially not present in the fuel composition and are eliminated by low-cut removal before one or more full distillations.

In some embodiments, the fatty acid ester fuel is a substantially clear and colorless fluid. Color and clarity can be good indicators of the removal of unreacted feedstock components. Also, highly colored biodiesel can have poor odor characteristics.

In some embodiments, the fatty acid ester fuel is a renewable CIEBSC derived from blends of animal tallow and dry distiller's corn oil. In some embodiments, the fatty acid ester fuel is a CIEBSC produced from a Blend Stock Feedstock Composition (BSFC) having the composition shown in Table 1.

TABLE 1
BSFC Composition.

| | Feedstock | Feedstock | | |
|---|---|---|---|---|
| Free Fatty | Blend 1 | Blend 2 | Feedstock 3 | Feedstock 4 |
| Acid | (% Mass) | (% Mass) | (% Mass) | (% Mass) |
| C6:0 | 0.0 | 0.0 | 0 | 0 |
| C8:0 | 0.0 | 0.0 | 0 | 0 |
| C10:0 | 0.0 | 0.0 | 0 | 0 |
| C11:0 | 0.0 | 0.0 | 0 | 0 |
| C12:0 | 0.1 | 0.1 | 0.2 | 0 |
| C13:0 | 0.0 | 0.0 | 0 | 0 |
| C14:0 | 1.3 | 1.5 | 2.9 | 0 |
| C14:1 | 0.0 | 0.0 | 0 | 0 |
| C15:0 | 0.2 | 0.3 | 0.6 | 0 |
| C15:1 | 0.0 | 0.0 | 0 | 0 |
| C16:0 | 18.7 | 18.2 | 24.3 | 12.1 |
| C16:1 | 1.8 | 1.1 | 2.1 | 0.1 |
| C17:0 | 0.5 | 0.6 | 1.2 | 0 |
| C17:1 | 0.2 | 0.3 | 0.4 | 0.1 |
| C18:0 | 10.7 | 12.3 | 22.8 | 1.8 |
| C18:1 | 34.7 | 33.7 | 40.2 | 27.2 |
| C18:2 | 29.3 | 29.8 | 3.3 | 56.2 |
| C18:3 | 1.3 | 1.0 | 0.7 | 1.3 |
| C20:0 | 0.2 | 0.3 | 0.2 | 0.4 |
| C20:1 | 0.2 | 0.3 | 0.6 | 0 |
| C20:2 | 0.0 | 0.0 | 0 | 0 |
| C20:3 | 0.0 | 0.0 | 0 | 0 |
| C20:4 | 0.0 | 0.0 | 0 | 0 |
| C20:5 | 0.0 | 0.0 | 0 | 0 |
| C21:0 | 0.0 | 0.0 | 0 | 0 |
| C22:0 | 0.2 | 0.1 | 0 | 0.2 |
| C22:1 | 0.1 | 0.0 | 0 | 0 |
| C22:2 | 0.0 | 0.0 | 0 | 0 |
| C22:6 | 0.0 | 0.0 | 0 | 0 |
| C23:0 | 0.0 | 0.0 | 0 | 0 |
| C24:0 | 0.0 | 0.0 | 0 | 0 |
| C24:1 | 0.0 | 0.0 | 0 | 0 |
| Unknown | 0.4 | 0.6 | 0.5 | 0.6 |
| % Total | 100 | 100 | 100 | 100 |

The substantial elimination of most sulfur compounds that are contributed by a CIEBSC feed has been found to result in a reduced odor. Also, blends containing reduced sulfur fuels can be less odiferous than those instead containing standard CIEBSC compositions. The total sulfur content of the CIEBSC can be less than 5 ppm, less than 4 ppm, less than 3 ppm, less than 2 ppm or less than 1 ppm. In some embodiments, the sulfur content is less than about 2 ppm.

Nitrogen-containing compounds can also impart odor to CIEBSC compositions. Nitrogen compounds present in feedstocks and fuels can include organic compounds such as amino acids. Amino acids typically have a low molecular weight, and can be removed with volatiles in multi-stage distillation processes. The nitrogen content of the CIEBSC can be less than 10 ppm, less than 9 ppm, less than 8 ppm, less than 7 ppm, less than 6 ppm, less than 5 ppm, less than 4 ppm, less than 3 ppm, less than 2 ppm, or less than 1 ppm. In some embodiments, the nitrogen content is less than about 1 ppm.

Traditionally produced FAME can comprise high molecular weight impurities, such as vitamin E, that are found in some feedstocks. The modified fatty acid ester fuel compositions described herein can have a reduction in high molecular weight component concentrations as a result of carefully controlled and limited thermal cracking during processing. This can result in a lower flash point for the composition, which can have the benefits of improving fuel properties such as cold soak filtration, cloud point, and viscosity. The flash point of the fatty acid ester fuel composition can be, for example, between about 45° C. and about 50° C., between about 50° C. and about 55° C., between about 55° C. and about 60° C., between about 60° C. and about 65° C., between about 65° C. and about 70° C., between about 70° C. and about 75° C., between about 75° C. and about 80° C., between about 80° C. and about 85° C., between about 85° C. and about 90° C., between about 90° C., and about 95° C., between about 95° C. and about 100° C., or between about 100° C. and about 105° C. The flash point of the CIEBSC can be greater than 90° C., greater than 91° C., greater than 92° C., greater than 93° C., greater than 94° C., or greater than 95° C. In some embodiments, the flash point is greater than 93° C.

The 5% distillation temperature of the CIEBSC can be at least about 200° C., at least about 205° C., at least about 210° C., at least about 215° C., at least about 220° C., or at least about 225° C. In some embodiments, the 5% distillation temperature is at least about 220° C. The 95% distillation temperature of the CIEBSC can be less than about 370° C., less than about 365° C., less than about 360° C., less than about 355° C., or less than about 350° C. In some embodiments, the 95% distillation temperature is less than about 355° C.

The cetane number of the fatty acid ester fuel composition can be another important factor in determining the quality of the fuel, with higher cetane numbers indicating shorter ignition delay periods. The cetane number of the fatty acid ester fuel composition can be, for example, between about 30 and about 35, between about 35 and about 40, between about 40 and about 45, between about 45 and about 50, between about 50 and about 55, between about 55 and about 60, between about 60 and about 65, or greater than about 65. The cetane number of the CIEBSC can be greater than about 45, greater than about 50, greater than about 55, greater than about 60, or greater than about 65. In some embodiments, the cetane number is greater than about 60.

Glycerin compounds present in feedstocks and fuels can include monoglycerides, diglycerides, and triglycerides. These glycerin compounds can foul components of a fuel system or compression engine, such as injectors or filters. The free glycerin content of the CIEBSC can be less than 0.02%, less than 0.019%, less than 0.018%, less than 0.017%, less than 0.016%, less than 0.015%, less than 0.014%, less than 0.013%, less than 0.012%, less than 0.011%, less than 0.01%, or less than 0.009%. The ATSM 6751 specification for free glycerin content is 0.02%.

The total glycerin content of the CIEBSC can be less than 0.045%, less than 0.04%, less than 0.035%, less than 0.03%, less than 0.025%, less than 0.02%, or less than 0.015%. The ATMS 6751 specification for total glycerin content is 0.045%. In some embodiments, the total glycerin content is less than about 0.02% (w/w).

The cloud point of the fatty acid ester fuel composition can indicate the tendency of the fuel composition to plug filters or small orifices at cold operating temperatures. Such filters and orifices can be elements of compression engines to be used with the fuel composition. The cloud point of the CIEBSC can be less than about 20° C., less than about 18° C., less than about 16° C., less than about 14° C., less than about 12° C., less than about 10° C., less than about 8° C., or less than about 6° C. In some embodiments, the cloud point is less than about 10° C.

The ability of the fatty acid ester fuel composition to absorb ultraviolet wavelengths of light at specific wavelengths can provide information regarding the chemical makeup of the fuel composition. For example, the aromatic content of the fuel composition can be approximated by measuring the UV absorbance at 272 nm (A₂₇₂) and at 310 nm (A₃₁₀). The aromatic content is then related to an absorbance value Aₜₒₜₐₗ, where Aₜₒₜₐₗ is calculated using the equation:

Aₜₒₜₐₗ=A₂₇₂10(A₃₁₀)

The UV absorbance, Aₜₒₜₐₗ, of the CIEBSC can be less than about 3.0, less than about 2.5, less than about 2.0, less than about 1.5, less than about 1.0, or less than about 0.5. In some embodiments, the UV absorbance, Aₜₒₜₐₗ, is less than about 1.5. In some embodiments, the UV absorbance, Aₜₒₜₐₗ, is less than about 0.5.

The clarity value of the fatty acid ester can be measured by using a standard assay procedure, such as that of ASTM D4174. The clarity value of the CIEBSC can be about 0.5, about 0.6, about 0.7, about 0.8, about 0.9, about 1.0, about 1.1, about 1.2, about 1.3, about 1.4, about 1.5, about 1.6, about 1.7, about 1.8, about 1.9, or about 2.0. In some embodiments, the clarity value is about 1.0.

In some embodiments, the fatty acid ester fuel composition has at least the following:
b. a nitrogen content of less than about 1 ppm,
h. a total glycerin content of less than about 0.02% (w/w), and
j. a UV absorbance, Aₜₒₜₐₗ, of less than about 0.5.

In some embodiments, the fatty acid ester fuel composition is blended with petroleum diesel. The blend can be a B2 blend containing 2% biodiesel blended with 98% petroleum diesel. The blend can be a B5 blend containing 5% biodiesel blended with 95% petroleum diesel. The blend can be a B20 blend containing between 6% and 20% biodiesel blended with petroleum diesel. The blend can be a B50 blend containing between 21% and 50% biodiesel blended with petroleum diesel. The blend can be a B100 blend containing pure biodiesel.

The NOx emissions for a B20 blended fuel can be less than 10%, less than 9%, less than 8%, less than 7%, less than 6%, less than 5%, less than 4%, less than 3%, less than 2%, or less than 1%. In some embodiments, the NOx emissions for a B20 blended fuel are less than 2%.

The NOx emissions for a B50 blended fuel can be less than 20%, less than 18%, less than 16%, less than 14%, less than 12%, less than 10%, less than 8%, less than 6%, or less than 4%. In some embodiments, the NOx emissions for a B50 blended fuel are less than 6%.

The NOx emissions for a B100 blended fuel can be less than 27%, less than 25%, less than 23%, less than 21%, less than 19%, less than 17%, less than 15%, less than 13%, less than 11%, or less than 9%. In some embodiments, the NOx emissions for a B100 blended fuel are less than 13%.

In some embodiments, when the fatty acid ester fuel composition is burned, the NOx emissions are:
less than 2% for B20 blended fuel,
less than 6% for B50 blended fuel, or
less than 13% for B100 blended fuel.

In some embodiments, when the fatty acid ester fuel composition is burned, the PM emissions for B20 to B100 compositions are reduced from 27% to 80% relative to petroleum diesel fuel emissions.

In some embodiments, the fatty acid ester fuel composition does not have reduced mileage when compared to petroleum diesel in fleet testing. In real-world testing, the consumption of fuel has not been shown to increase with the use of the lower energy density of the provided fuel compositions.

### IV. Methods of Preparing Fatty Acid Ester Fuel Compositions

In some embodiments, the present invention provides several methods for preparing fatty acid ester fuel compositions. In some embodiments, the present invention provides a method comprising heating a fatty acid methyl ester feedstock in a first vacuum tower at a temperature of at least about 500° F. and a pressure of less than about 760 Torr. The method further comprises separating a first fraction of glycerin thereby providing a first fraction of fatty acid methyl ester substantially free of an alcohol and having a total glycerin content of less than about 1% (w/w). The method further comprises heating the first fraction of fatty acid methyl ester in a second vacuum tower at a temperature of at least about 600° F. and a pressure of less than about 760 Torr. The method further comprises separating a second fraction of glycerin from the first fraction of fatty acid methyl ester to form a second fraction of fatty acid methyl ester having a free glycerin content of less than about 0.02% (w/w) and a total glycerin content of less than about 0.05% (w/w), thereby forming the fatty acid methyl ester fuel of the present invention.

In some embodiments, the feedstock is pretreated to reduce acidity. The acid reduction system can use a continuous-flow acid esterification with a mineral or organic acid catalyst contained in heated, pressurized, acid-resistant piping. The acid-resistant piping can be lined with a material such as TEFLON® or can comprise high-grade stainless steel. In some embodiments, the piping does not comprise acid-resistant material and an operating pressure and temperature are selected for compatibility with the reaction conditions. Higher temperatures can be used with a mixture of methanol and whole oil, or a mixture of methanol and free fatty acid (FFA) that has been separated from the whole oil by a countercurrent wash system. Increasing the temperature and pressure to 300° F. and 300 psi and adding acid catalyst can induce both esterification and transesterification.

The esterified oils can carry water and acid into the transesterification reactor. The acidity can be neutralized before the addition of an alkali catalyst. Methanol can be extracted from the transesterified mixture by using a methanol extraction and drying system before separating the glycerol. This system can use staged centrifuges to send highly purified methyl ester into the distillation system.

In some embodiments, the cold soak filtration filter time of the fatty acid ester fuel composition is reduced through the reduction of high molecular weight aromatics and other impurities through top- and bottom-cut distillations. Some inter-FFA polymerization, that can be a byproduct of animal fat rendering, can result in longer filter times. The provided methods can be used to break polymers into individual FFA components or to remove the polymers from final cuts of CIEBSC through distillation. Other impurities that can cause cold soak filter time (CSFT) failure also do not distill at the temperature ranges of the CIEBSC and are thus removed from the finished product.

In some embodiments, the methods produce a substantially clear and colorless fuel. The distillations can produce a substantially clear and colorless upper liquid stream and a dark tower bottom component. The dark tower pigments can contain high molecular weight compounds that do not distill and are likely to be feedstock impurities and unreacted components. These feedstock components can produce hot spots and reactions during fuel combustion that can result in increasing NOx and PM emissions.

In some embodiments, the feedstock is a blend having between about 1% and about 3% unreacted glycerides. In some embodiments, the feedstock blend has from about 0.1% to about 0.5% free glycerin. In some embodiments, the first vacuum tower removes substantially all alcohol and 99% of the free glycerol from the feedstock. In some embodiments, the blend stock collected in from the second vacuum tower has a free glycerin content of less than 0.009% and a total glycerin content of less than 0.045%.

In some embodiments, the method further comprises heating the second fraction of fatty acid methyl ester in a third vacuum tower at a temperature of at least about 515° F. and a pressure of less than about 760 Torr, cracking at least 1% of the fatty acid methyl esters and lowering the flash point, thereby forming the fatty acid methyl ester fuel of the present invention. In some embodiments, at least 5% of the mono alkyl esters are cracked in this step of the method. The blend stock can realize a drop in flash point which can be used to control the degree of thermal cracking. The thermal cracking can be carried out in the presence of a catalyst or in the absence of a catalyst. In some embodiments, the catalyst is an acid catalyst. In some embodiments, the catalyst is a solid acid catalyst. In some embodiments, the catalyst comprises silica-alumina. In some embodiments, the catalyst comprises a zeolite.

### V. Systems for Preparing Fatty Acid Ester Fuel Compositions

In some embodiments, the present invention provides several systems for preparing fatty acid ester fuel compositions. In some embodiments, the present invention provides a system comprising a first vacuum tower having a bottom and a top. The system further comprises a second vacuum tower having a bottom and a top. The second vacuum tower is connected to the bottom of the first vacuum tower via a first pipe. The system further comprises a first overhead partial condenser connected to the top of the second vacuum tower. The system further comprises a first secondary condenser connected to the first partial condenser via a second pipe. The system further comprises a third vacuum tower having a bottom and a top. The third vacuum tower is connected to the bottom of the second vacuum tower via a third pipe. The third vacuum tower is also connected at the top to a second overhead partial condenser, a second secondary condenser, and a re-boiler.

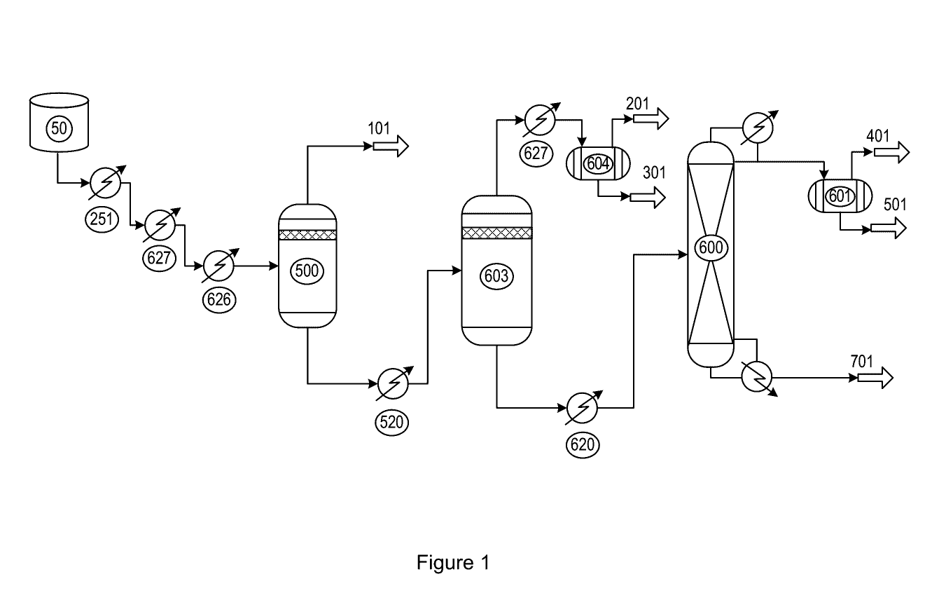

FIG. 1 illustrates a process system in accordance with an embodiment. Shown is a vessel 50 used to store crude blend feedstock. The blend stock can be pumped through heat exchangers 251, 627, and 626 to vessel 500. In some embodiments, the pumping is at 7 atmospheres pressure. In some embodiments, the staged heating from vessel 50 to vessel 500 is to a temperature of 500° F. Volatile materials are flashed under vacuum in vessel 500, with the distillate 101 being returned to the reaction plant. Bottoms from vessel 500 are pumped through heat exchanger 520 to vessel 603. In some embodiments, the heating from vessel 500 to vessel 603 is to a temperature of 600° F. Blend stock and glycerin are then flashed under vacuum in vessel 603. The distillate is partially condensed in overhead partial condenser 627. Glycerin and other volatiles are extracted as vapor stream 201 from secondary condenser 604. Blend stock is recovered in stream 301 and sent to storage. Bottoms from vessel 603 are pumped through heat exchanger 620 to vessel 600. In some embodiments, the heating from vessel 603 to vessel 600 is to a temperature of 515° F. The blend stock is distilled under vacuum in vessel 600 with constant reboil and reflux. The distillate is partially condensed in vessel 601, with the volatiles removed as vapor in stream 401 and the blend stock recovered and sent through stream 501 to storage. Bottoms from tower 600 are sent to storage in stream 701.

In some embodiments, the feedstock blend in vessel 50 has between about 1% and 3% unreacted glycerides. In some embodiments, the feedstock blend has between about 0.1% and about 0.5% free glycerin. In some embodiments, 99% or more of the alcohols and free glycerol in the blend stock are removed in the distillation within vessel 500.

In some embodiments, from about 50% to about 80% of the distillable blend stock is taken overhead from the second vacuum tower and partially condensed. The remaining free glycerin in vapor form is transferred to the first secondary condenser for removal.

In some embodiments, the reboiler is operated at a specific elevated temperature selected to thermally crack at least 5% of the mono alkyl esters present. The blend stock can realize a drop in flash point which is used to control the degree of thermal cracking. The thermal cracking can be done with or without the presence of a catalyst.

In some embodiments, the overhead condensate from streams 301 and 501 are combined to form the fatty acid ester fuel composition. In some embodiments, the fatty acid ester composition is a CIEBSC that meets ASTM 6751 specifications.

In some embodiments the CIEBSC is blended with ULS diesel at levels from 5% to 20% to produce B5 to B20 fuel blends suitable for use in compression ignition engines. In some embodiments, when these fuel blends are tested under CARB FTP CE-CERT protocols, the results show NOx emission neutrality to petroleum diesel, and reduced PM, CO₂, CO, and THC emissions relative to petroleum diesel.

### VI. Examples

### Example 1

### Fuel Preparation

The initial blendstock is refined in the process outlined in FIG. 1. The feedstock used initially can be a variety of organic based oils, usually but not necessarily containing high percentages of C18 and C16 carboxylic acids combined into glycol esters. More or less of this feedstock can have broken down into “free fatty acids” before the initial blend stock production. The feedstock can be prepared by blending multiple different sources to produce an optimum composition. The process is insensitive to unsaponifiables, as well as to metals and other impurities.

The crude initial blendstock is dry and has low concentrations of free glycerol at <100 ppm and total glycerides at <0.5%. Salts and other impurities are largely removed prior to this stage. In the first step, the mixture is flashed in vessel 500 at 440° F. and 35 Torr to remove glycerol and methanol via stream 101. The remaining blend stock is then fed into vessel 603 and heated at 550° F. at 30 Torr, where the vessel 603 is fitted with an overhead partial condenser 604 to collect FAME as stream 301. In vessel 603, 50% to 80% of the distillable blendstock is taken overhead, partially condensed to drop the blendstock out and the remaining free glycerin now in vapor form is removed in the second condenser. The blend stock collected in this step has a free glycerin % less than 0.009 and total glycerin % less than 0.05.

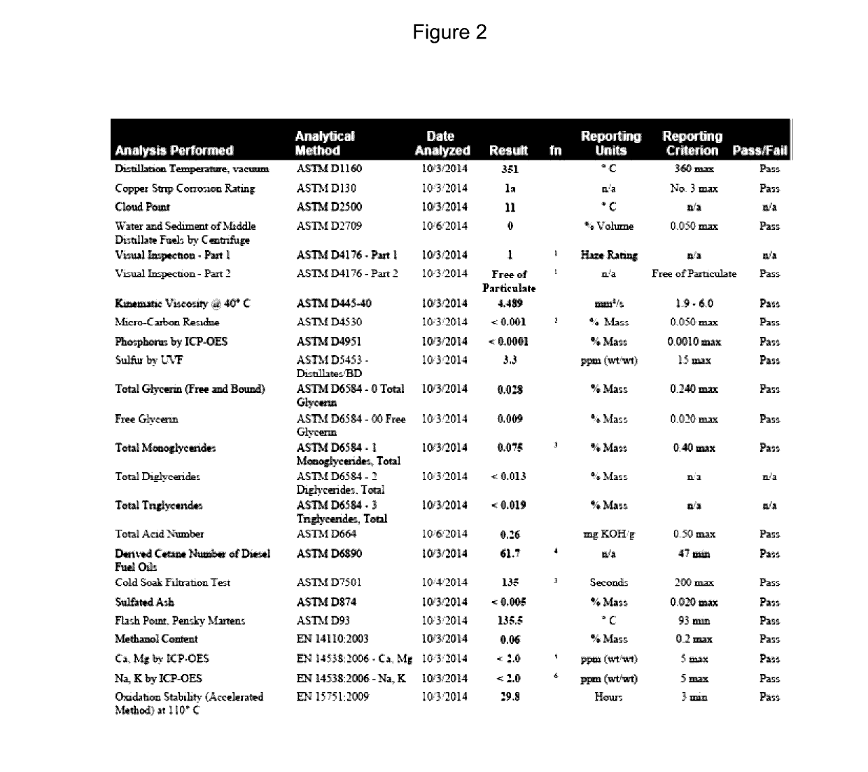

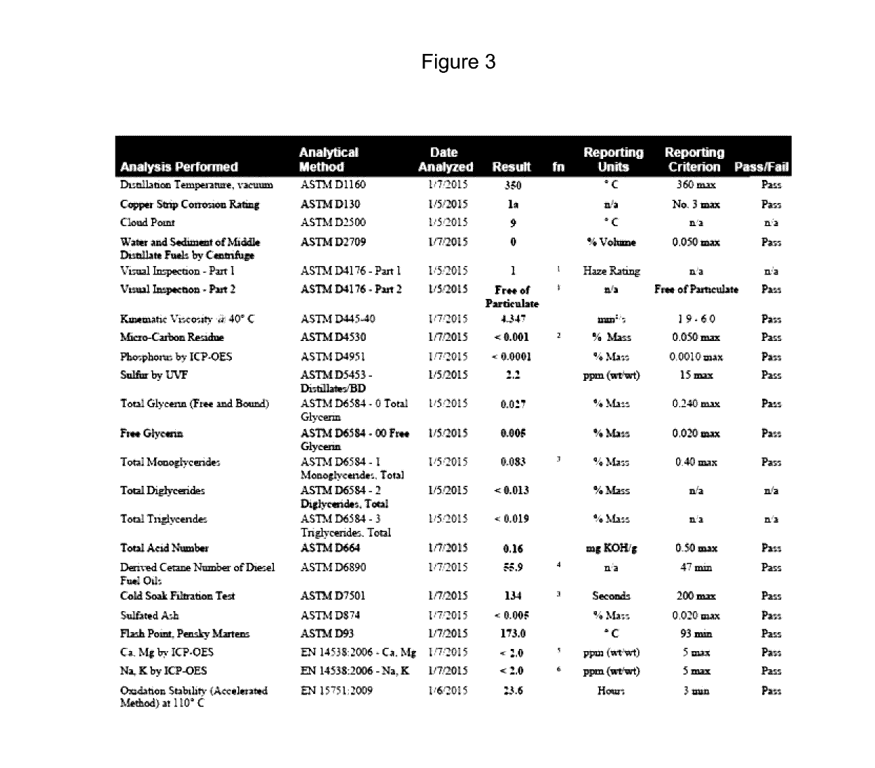

The mixture left in the bottom of the vessel 603 is transferred to vessel 600 fitted with a partial overhead condenser 601 and heated to 515° F. at 30 Torr. The blendstock distilled in this tower goes overhead and is condensed in the partial condenser 601 operating at a temperature of 380 F at 25 Torr to form stream 601 of FAME. The streams 501 and 301 extracted from vessels 600 and 603 are combined to produce the final product that compares with the specification for CIEBSC. Fuel prepared by this method and compliant with ASTM 6751 is characterized in FIG. 2 and FIG. 3.

### Example 2

### Wiped Film Evaporator & Glycerolysis

Dehydrated glycerin and FAME emulsion is fed to an evaporator at 170° F. The evaporator shell is held at a controlled temperature of 350° F. to 450° F. utilizing a hot oil system. The pressure in the evaporator is less than 760 torr. The evaporator feed contains less than 0.5% water and less than 0.5% methanol by mass.

The distillate of the evaporator is a two-phase mixture of glycerin and FAME. The glycerin makes up approximately 50% by mass of the distillate, with the remainder consisting of FAME. The distillate is over 50% of the feed by mass as tested by HPLC. Once separated by centrifuge, the glycerin is greater than 90% pure as measured by mass spectrometry. The glycerin can be sold as a product. The FAME is recycled back to the primary process and is distilled with the main FAME stream. The bottoms from the evaporator are comprised of Matter Organic Non-Glycerol (MONG), salts, and other unsaponifiables.

This piece of equipment allows for the recovery of high purity glycerin and FAME without neutralizing the glycerin stream. The yield loss attributed to running animal tallows as feedstock is generally associated with product that is not able to be separated from the glycerin with decanting or centrifuging. The process forms a emulsion, suspending methyl ester and other in the glycerin. The wiped film evaporator is able to separate these products without the side effects seen in distillation towers, such as foaming and product breakdown.

Purified glycerol from the wiped film evaporator is heated and mixed with or without zinc acetate dihydrate or dehydrated zinc acetate so that the final glycerol mixture has a zinc concentration of 0.00-10.00% by mass. The glycerol mixture is added to a heated and mixed feedstock tank in an amount such that the total mass of glycerol is 1.0-3.0 times the stoichiometric amount of glycerol needed for the mass percentage of free fatty acids in the feedstock, and the total zinc concentration of the entire mixture of glycerol and feedstock is between 0.00 and 0.50% by mass. The tank has nitrogen stripping throughout the mixture at a ratio of approximately 1-4 tank volumes per hour to prevent oxidation and aid in water removal. The temperature of the mixture will be between 300-400° F. Mixing rates will range between 200 and 500 rpm and may include a recirculator loop with a high shear mill. The mixture will typically react under these conditions for a minimum of 2 hours but no longer than 48 hours. After such time, the tank mixture will settle and the reduced free fatty acid (FFA) feedstock will enter the plant for base catalyzed transesterification using the stated process.

### Example 3

### Emissions of CIEBSC Compared with Ultra Low Sulfur Diesel (ULSD) and Other Blend Stocks

Table 2 below presents comparative data of emission characteristics of B20, B50, and B100 fuel blends prepared with CIEBSC of the present invention, relative to the same characteristics as measured with multiple biodiesel alternatives.

TABLE 2
Comparison of emissions of ULSD with biodiesel blends.

| | Biodiesel Type | PM | THC | CO | NOx |
|---|---|---|---|---|---|
| B20 | Soy | −25% | −11% | 0.0% | 6.6% |
| | Animal Tallow | 19% | −13% | −7% | 1.5% |
| | AGRON Process | −31.1% | −9.3% | −16.2% | 1.7% |
| | (AF + COME) | | | | |
| | AGRON Process (AFME-1) | −29.7% | −15.3% | −16.0% | 1.7% |
| | AGRON Process (AFME-2) | −27.3% | −15.1% | −16.5% | — |
| B50 | Soy | −46% | −36% | −4% | 13.2% |
| | Animal Tallow | 42% | −29% | −14% | 6.4% |
| | AGRON Process | −56.9% | −25.2% | −29.8% | 5.1% |
| | (AF + COME) | | | | |
| | AGRON Process (AFME-1) | −53.7% | −19.8% | −27.6% | 2.7% |
| | AGRON Process (AFME-2) | −53.0% | −23.8% | −29.1% | 7.0% |
| B100 | Soy | −58% | −71% | 0.0% | 26.6% |
| | Animal Tallow | −64% | −63% | −27% | 14.1% |
| | AGRON Process | −77.1% | −32.3% | −49.6% | 12.2% |
| | (AF + COME) | | | | |
| | AGRON Process (AFME-1) | −76.1% | −47.3% | −52.6% | 7.0% |
| | AGRON Process (AFME-2) | −74.7% | −42.7% | −49.9% | 5.6% |

Although the foregoing invention has been described in some detail by way of illustration and example for purposes of clarity of understanding, one of skill in the art will appreciate that certain changes and modifications may be practiced within the scope of the appended claims. In addition, each reference provided herein is incorporated by reference in its entirety to the same extent as if each reference was individually incorporated by reference. Where a conflict exists between the instant application and a reference provided herein, the instant application shall dominate.

What is claimed is:

1. A fatty acid ester fuel composition comprising at least one fatty acid ester, wherein the composition has at least five of the following:
a. a sulfur content of less than about 10 ppm,
b. a nitrogen content of less than about 10 ppm,
c. a flash point of greater than about 93° C.,
d. a 5% distillation temperature of at least about 220° C.,
e. a 95% distillation temperature of less than about 355° C.,
f. a cetane number of greater than about 60,
g. a free glycerin content of less than about 0.009% (w/w),
h. a total glycerin content of less than about 0.045% (w/w),
i. a cloud point of less than about 10° C.,
j. a UV absorbance, Aₜₒₜₐₗ, of less than about 1.5, and
k. a clarity value of about 1 as measured by ASTM D4174.

2. The fatty acid ester fuel composition of claim 1, wherein the sulfur content is less than about 2 ppm.

3. The fatty acid ester fuel composition of claim 1, wherein the total glycerin content is less than about 0.02% (w/w).

4. The fatty acid ester fuel composition of claim 1, wherein the nitrogen content is less than about 1 ppm.

5. The fatty acid ester fuel composition of claim 1, wherein the UV absorbance, Aₜₒₜₐₗ, is less than about 0.5.

6. The fatty acid ester fuel composition of claim 1, having at least the following:
b. a nitrogen content of less than about 1 ppm,
h. a total glycerin content of less than about 0.02% (w/w), and
j. a UV absorbance, Aₜₒₜₐₗ, of less than about 0.5.

7. The fatty acid ester fuel composition of claim 1, wherein the NOₓ emissions when the fuel is burned are:
less than 2% for B20 blended fuel,
less than 6% for B50 blended fuel, or
less than 13% for B100 blended fuel.

8. A method of preparing the fatty acid ester fuel composition of claim 1, comprising:
heating a fatty acid methyl ester feedstock in a first vacuum tower at a temperature of at least about 500° F. and a pressure of less than about 760 Torr;
separating a first fraction of glycerin thereby providing a first fraction of fatty acid methyl ester substantially free of an alcohol and having a total glycerin content of less than about 1% (w/w);
heating the first fraction of fatty acid methyl ester in a second vacuum tower at a temperature of at least about 600° F. and a pressure of less than about 760 Torr; and
separating a second fraction of glycerin from the first fraction of fatty acid methyl ester to form a second fraction of fatty acid methyl ester having a free glycerin content of less than about 0.02% (w/w) and a total glycerin content of less than about 0.05% (w/w), thereby forming the fatty acid ester fuel of claim 1.

9. The method of claim 8, further comprising:
heating the second fraction of fatty acid methyl ester in a third vacuum tower at a temperature of at least about 515° F. and a pressure of less than about 760 Torr, cracking at least 1% of the fatty acid methyl esters and lowering the flash point, thereby forming the fatty acid methyl fuel of claim 1.

10. A system for preparing a fatty acid ester fuel composition of claim 1, comprising:
a first vacuum tower having a bottom and a top;
a second vacuum tower, having a bottom and a top, connected to the bottom of the first vacuum tower via a first pipe;
a first overhead partial condenser connected to the top of the second vacuum tower;
a first secondary condenser connected to the first partial condenser via a second pipe; and
a third vacuum tower, having a bottom and a top, connected to the bottom of the second vacuum tower via a third pipe, and also connected at the top to a second overhead partial condenser, a second secondary condenser, and a re-boiler.
